(19) United States
(12) Patent Application Publication
(10) Pub. No.: US 2007/0025744 A1
(43) Pub. Date: Feb. 1, 2007

(54) Image forming apparatus including a sensor actuator to which toner does not stick

(75) Inventors: In-hwan Joo, Suwon-si (KR); Yong-whan Park, Suwon-si (KR); Dong-ju Kang, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/369,833

(22) Filed: Mar. 8, 2006

(30) Foreign Application Priority Data
Jul. 26, 2005 (KR) 2005-67651

(51) Int. Cl. G03G 15/00

(52) U.S. Cl. 399/16

(57) ABSTRACT

Disclosed is an image forming apparatus, including a body in which toner is applied to a printed side of a print medium during a printing operation. The apparatus includes a medium transferring path defined in the body, along which the print medium is transferred during the printing operation, a sensor actuator, disposed in the medium transferring path, to be pivoted by the print medium as the print medium is transferred, a toner sticking prevention member, disposed on the sensor actuator, to contact the printed side of the print medium as the print medium is transferred passed the sensor actuator, the toner sticking prevention member being made of materials to which the toner does not stick, a paper sensor to sense the pivoting of the sensor actuator, and a control portion to perceive the transfer of the print medium according to a signal of the paper sensor.

### CROSS-REFERENCE TO RELATED APPLICATIONS

This application claims the benefit of Korean Application No. 2005-67651, filed Jul. 26, 2005, in the Korean Intellectual Property Office, the disclosure of which is incorporated herein by reference.

### BACKGROUND OF THE INVENTION

1. Field of the Invention

An aspect of the present invention relates to an image forming apparatus, and, more particularly, to an image forming apparatus using toner.

2. Description of the Related Art

In an image forming apparatus using toner, generally, a predetermined toner image is formed in a development unit according to printing data and is transferred onto a print medium. Then, the print medium on which the toner image is transferred passes through a fixing unit, and the toner is fixed on the print medium by the fixing unit to complete the printing.

One example of a fixing unit of the conventional image forming apparatus is shown in FIG. 1. With reference to FIG. 1, the conventional fixing unit comprises a pressure roller 1, a heating roller 3, a paper-rolling prevention unit 5, a sensor actuator 7, and a paper sensor 9.

The heating roller 3 generates heat by an internal heating device (not shown) so as to melt a toner image on a print medium P. The pressure roller 1 is disposed to be in contact with the heating roller 3 to rotate with the heating roller 3, and to bias the heating roller 3 by an elastic member 2, e.g., a spring. The surface of the pressure roller 1 is made of a silicon rubber layer. The paper-rolling prevention unit 5 is disposed to be in contact with the surface of the heating roller 3 to prevent the print medium P, which passes between the heating roller and the pressure roller 1, from rolling on to the heating roller 3. The sensor actuator 7 is disposed downstream from the pressure roller 1 so as to be pivoted, at a predetermined angle, by the print medium P passing through the fixing unit. The paper sensor 9 is disposed at the lower part of the sensor actuator 7, to sense the pivoting of the sensor actuator 7 by the print medium P and to send a signal to a control portion (not shown) of the image forming apparatus.

Upon a printing by the aforementioned image forming apparatus, the development unit (not shown) forms the toner image according to printing data, and transfers the toner image on the print medium P. The print medium P, with the transferred toner image, enters between the heating roller 3 and the pressure roller 1 of the fixing unit. Then, the toner image is fixed on the print medium P by the heat of the heating roller 3 and the pressure of the pressure roller 1. The print medium P, passing between the heating roller 3 and the pressure roller 1, pushes the sensor actuator 7 to pivot at the predetermined angle, and then the print medium P is transferred (see FIG. 2). Here, the paper sensor 9 senses the pivoting of the sensor actuator 7 and sends the signal to the control portion (not shown). If the print medium P passes through the sensor actuator 7, the sensor actuator 7 returns to the state as shown in FIG. 1, and the paper sensor 9 again sends the signal to the control portion. Then, if the control portion perceives that the print medium P passes through the fixing unit, the control portion stops the operation of the fixing unit. The print medium P passing through the sensor actuator 7 is ejected out of the image forming apparatus by an eject roller (not shown).

However, where a relatively large volume of printing is done by the conventional image forming apparatus, as described above, toner accumulates on the surface 7a of the sensor actuator 7, which remains in contact with the print medium P. FIG. 3 is a photograph showing the toner accumulating on the sensor actuator 7. In FIG. 3, the portion where the toner accumulates on the sensor actuator 7 is encircled. Toner accumulation occurs when a downward-facing side of one sheet of the print medium P contacting the sensor actuator 7 is a toner printed side. That is, the toner accumulates on the sensor actuator upon a printing of both sides of the printing medium or a printing of one side of the print medium where the other side (downward-facing side) has been previously printed.

A process of accumulating toner on the contact surface 7a of the sensor actuator 7 will now be described in detail. The print medium P passing through the fixing unit is transferred, causing the sensor actuator 7 to pivot at the predetermined angle. Here, the downward-facing side of the print medium P and the sensor actuator 7 come into contact with each other. Then, the toner on the downward-facing side of the print medium P tends to stick, in relatively small quantities, to the surface 7a of the sensor actuator 7 contacting the print medium P. If printing is continuously performed, the toner continuously accumulates on the contact surface 7a of the sensor actuator 7 and ultimately hardens.

If the toner accumulation continues, the print medium P, which is to freely pass through the fixing unit, may be stopped by the toner, which has accumulated on the sensor actuator 7. As a result, the print medium P is prevented from freely passing through the fixing unit, resulting in a paper jam. As removal of the print medium P where the print medium P is jammed between the fixing unit and the sensor actuator 7 is relatively difficult, the sensor actuator 7 may be inadvertently damaged by the paper jam removal process. Moreover, even where the jammed print medium is removed, a problem may exist in that the jam may continuously re-occur unless the toner accumulating on the sensor actuator 7 is removed.

Furthermore, even if the accumulating toner does not cause the print medium P to jam, another problem exists in that a phenomenon of a scratching of an image occurs if the accumulating toner scratches the downward-facing side of the print medium.

In order to solve the aforementioned and/or other problems, a user may remove the accumulating toner by having the forming image apparatus serviced. However, this results in increased service cost.

### SUMMARY OF THE INVENTION

Accordingly, it is an aspect of the present invention to provide an image forming apparatus, which overcomes the problem of toner, printed on a downward-facing side of a print medium, sticks to and accumulates on a sensor actuator.

The above and/or other aspects of the present invention is/are substantially realized by providing an image forming apparatus, including a body in which toner is applied to a printed side of a print medium during a printing operation, comprising a medium transferring path defined in the body, along which the print medium is transferred during the printing operation, a sensor actuator, disposed in the medium transferring path, to be pivoted by the print medium as the print medium is transferred, a toner sticking prevention member, disposed on the sensor actuator, to contact the printed side of the print medium as the print medium is transferred passed the sensor actuator, the toner sticking prevention member being made of materials to which the toner does not stick, a paper sensor to sense the pivoting of the sensor actuator, and a control portion to perceive the transfer of the print medium according to a signal of the paper sensor.

The toner sticking prevention member may be made of metallic materials, specifically, stainless steel (SUS). Further, the toner sticking prevention member may be formed to protect/cover the area of the sensor actuator that comes into contact with the print medium to cause the sensor actuator to pivot.

In accordance with another aspect of the present invention, the present invention is substantially realized by providing an image forming apparatus, including a body in which toner of an image is applied to a printed side of a print medium during a printing operation, comprising a development unit, disposed in the body, to form the image on the print medium, a fixing unit, disposed downstream from the development unit, to fix the image formed by the development unit onto the print medium, a sensor actuator, disposed in the medium transferring path, to be pivoted by the print medium as the print medium is transferred, a toner sticking prevention member, disposed on the sensor actuator, to contact the printed side of the print medium as the print medium is transferred passed the sensor actuator, the toner sticking prevention member being made of materials to which the toner does not stick, a paper sensor to sense the pivoting of the sensor actuator, and a control portion to perceive the transfer of the print medium according to a signal of the paper sensor.

In accordance with the image forming apparatus of the present invention as described above, the toner printed on the downward-facing side of the print medium does not stick to and accumulate on the contact surface of the sensor actuator since the toner sticking prevention member is disposed on the surface of the sensor actuator that contacts the print medium. Therefore, an image forming apparatus, according to aspects of the present invention, may be provided in which a jam or a scratch of an image is not generated due to toner accumulation.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view schematically showing a fixing unit of the conventional image forming apparatus;

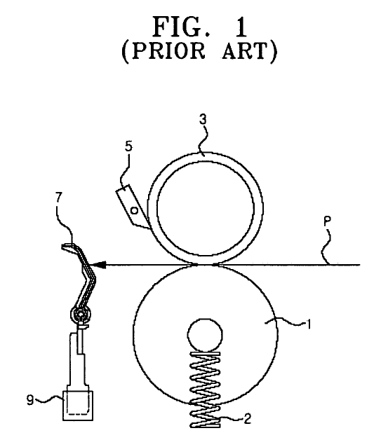

FIG. 2 is a cross-sectional view showing a sensor actuator of FIG. 1 pivoting by a print medium;

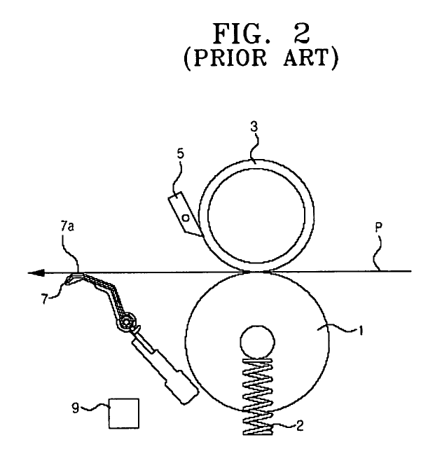

FIG. 3 is a photograph showing toner accumulating on the sensor actuator of the conventional image forming apparatus;

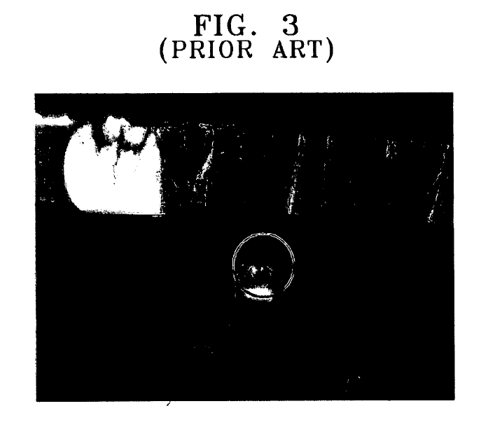

FIG. 4 is a cross-sectional view schematically showing one embodiment of an image forming apparatus according to an embodiment of the present invention;

FIG. 5 is a front view showing a fixing unit and a sensor actuator of the image forming apparatus of, FIG. 4;

FIG. 6 is a perspective view showing a toner sticking prevention member disassembled from the sensor actuator of FIG. 4;

FIG. 7 is a perspective view showing the toner sticking prevention member engaged with the sensor actuator of FIG. 4;

FIG. 8 is a view showing the sensor actuator pivoting by a print medium in the image forming apparatus of FIG. 4; and

FIG. 9 is a photograph showing the toner sticking prevention member after printing 6,000 sheets by the image forming apparatus according to the embodiment of the present invention shown in FIGS. 4-8.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the FIGS.

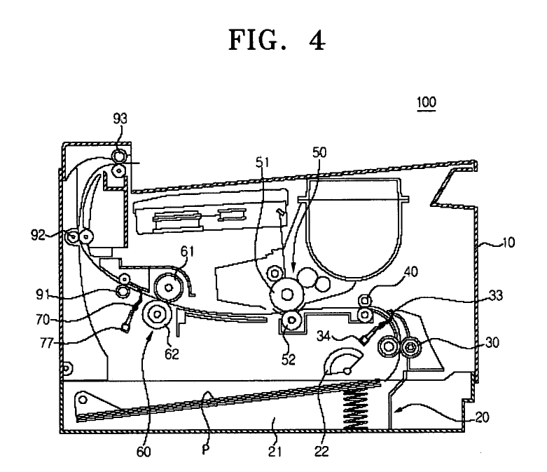

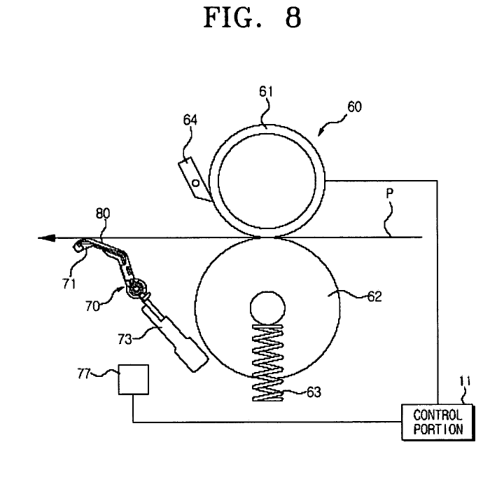

With reference to FIG. 4, an image forming apparatus, according to an embodiment of the present invention 100, comprises a body 10, a paper feed unit 20, a multi-feeding prevention roller 30, a register roller 40, a development unit 50, a fixing unit 60, a plurality of paper eject rollers 91, 92 and 93, and a control portion 11 (see FIG. 8). The multi-feeding prevention roller 30, the register roller 40, the development unit 50, the fixing unit 60 and the plurality of paper eject rollers 91, 92 and 93 form a medium transferring path along which a print medium P moves during a printing operation. For purposes of clarity, when the print medium is located at some position along the medium transferring path, the paper feed unit 20 is referred to as being upstream, and the plurality of paper eject rollers 91, 92 and 93 is referred to as being downstream.

The paper feed unit 20 is disposed at the lower part of the body 10 and comprises a paper feed cassette 21 on which a predetermined number of sheets of the print medium P are loaded, and a pickup roller 22, disposed at a leading edge of the paper feed cassette 21, to pick up individual sheets of the print medium P one by one to be supplied.

The multi-feeding prevention roller 30 prevents the print medium P, supplied by the paper feed unit 20, from being transferred to the register roller 40 by two or more sheets at a time. The register roller 40 aligns the leading edge of the print medium P so as to transfer the print medium P to the development unit 50 with a proper orientation.

The development unit 50 forms a predetermined electrostatic latent image corresponding to printing data on a photosensitive medium 51, develops the latent image using toner and forms a toner image. Then, a transfer roller 52 transfers the toner image formed on the photosensitive medium 51 to the transferred print medium P.

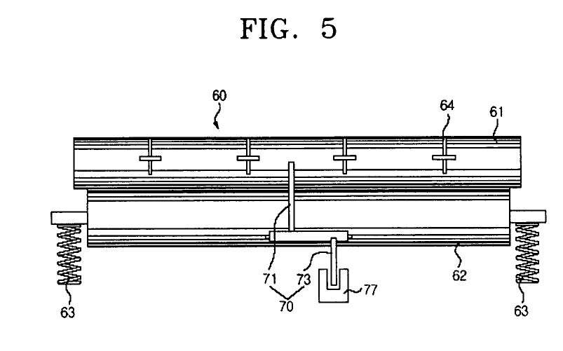

As shown in FIG. 5, the fixing unit 60 comprises a heating roller 61, a pressure roller 62, and a plurality of paper-rolling prevention units 64. The heating roller 61 melts the toner on the print medium P by an application of heat that is generated by internal heating devices. The pressure roller 62 is disposed so as to be in contact with the heating roller 61 to rotate with the heating roller 61, and biases the heating roller 61 with predetermined pressure. Both ends of the pressure roller 62 are supported with elastic members, e.g., a spring 63, and the surface of the pressure roller 62 is made of a silicon rubber layer. The plurality of paper-rolling prevention units 64 are disposed downstream of the heating roller 61. These units prevent the print medium P, passing between the heating roller 61 and the pressure roller 62, from rolling along the heating roller 61.

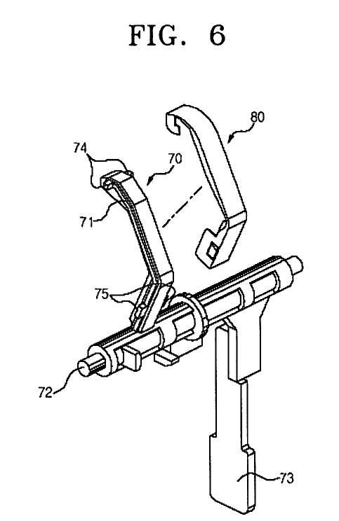

The sensor actuator 70 is disposed downstream of the pressure roller 62 and pivots at a predetermined angle as a result of the print medium P passing through the fixing unit 60. Here, the sensor actuator 70 may be disposed so as to be close to and downstream of the pressure roller 62. With reference to FIG. 6, the sensor actuator 70 comprises a contact portion 71 to be in contact with the print medium P, a pivot axis 72, and a sensor portion 73 to operate a paper sensor 77, which will be described later. Each side of the contact portion 71 is provided with a first protrusion 74 and a second protrusion 75, which are respectively spaced from each other at a predetermined interval and which are respectively engaged with the toner sticking prevention member 80. When no pressure is applied to the sensor actuator 70, the sensor actuator 70 is disposed such that the sensor portion 73 is positioned in the sensing area of the paper sensor 77.

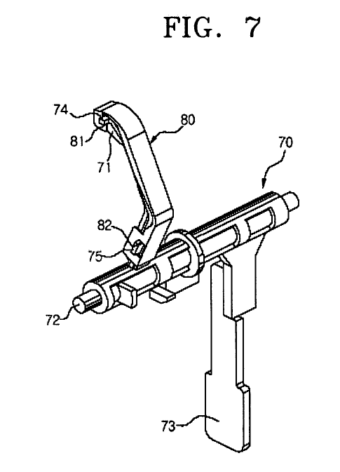

The toner sticking prevention member 80 is disposed on the upper surface of the contact portion 71 of the sensor actuator 70, i.e., the contact portion 71 contacting the downward-facing side of the print medium P, while the print medium P is transferred (see FIG. 7). The toner sticking prevention member 80 is formed to have a length that is sufficient to cover the contact portion 71 of the sensor actuator during the transfer of the print medium P. Each side of the toner sticking prevention member 80 is provided with a first groove 81 and a second groove 82, which correspond to the first protrusion 74 and the second protrusion 75 of the sensor actuator 70, respectively. Thus, when the toner sticking prevention member 80 is fitted with the upper surface of the contact portion 71 of the sensor actuator 70, the first and second protrusions 81 and 82 of the sensor actuator 70 are inserted into the first and second grooves 81 and 82 of the toner sticking prevention member 80, as shown in FIG. 7. The toner sticking prevention member 80 is made of materials to which the toner does not stick. The toner is printed on the downward-facing side of the print medium P while the surface of the print medium P with the toner image printed thereon is transferred while being in sliding contact with the toner sticking prevention member 80. That is, the materials forming the toner sticking prevention member 80 must not stick with the toner printed on the downward-facing side of the print medium P as a result of the sliding friction between the print medium P and the toner sticking prevention member 80. Although metal materials have sufficient non-sticking qualities, in an embodiment of the invention, the toner sticking prevention member 80 is particularly made of stainless steel (SUS).

The toner sticking prevention member 80 shown in FIGS. 6 and 7 is described as one example only. In fact, as long as the upper surface of the contact portion 71 of the sensor actuator 70 is capable of guiding the transfer of the print medium P without contacting the downward-facing side of the print medium P, there are various methods of connecting the toner sticking prevention member 80 to the sensor actuator 70. For example, although not shown, a plate-shaped toner sticking prevention member, which corresponds to the upper surface of the contact portion 71 of the sensor actuator 70, may be made of stainless steel and may be fixed on the upper surface of the sensor actuator 70 by a coupling member, such as a screw. Alternately, the toner sticking prevention member 80 may also be plate shaped so as to be fixable on the upper surface of the sensor actuator 70 by an adhesive. In yet another embodiment, the toner sticking prevention member is integrally formed with the sensor actuator 70. That is, forming the toner sticking prevention member 80 in the plate shape and molding the toner sticking prevention member 80 to the sensor actuator 70 is possible.

In addition, preventing the toner printed on the print medium from sticking to and accumulating on the contact portion 71 of the sensor actuator 70 is possible by manufacturing the sensor actuator 70 with metal materials, e.g., stainless steel, such that the toner does not stick to the contact surface 71. However, a problem with this method is that, with respect to manufacturing methods, cost or product weight, this method does not compare well to the method of manufacturing the sensor actuator 70 by plastic molding and then attaching the separate toner sticking prevention member 80 onto the upper surface of the sensor actuator 70.

The paper sensor 77 disposed at the lower part of the sensor actuator 70 senses the pivoting of the sensor actuator 70 as a result of contact with the print medium P and sends a signal to the control portion 11 (see FIG. 8). Although the sensor may comprise various sensing devices and may be any shape, as long as the paper sensor 77 is capable of sensing the pivoting of the sensor actuator 70, in a particular embodiment, the paper sensor 77 is a photo sensor in the shape as shown in FIG. 5.

The plurality of paper eject rollers 91, 92 and 93 comprise a first paper eject roller, a second paper eject roller and a third paper eject roller to eject the print medium P on which the toner image is fixed while it passes through the fixing unit, out of the body 10.

The control portion 11 (see FIG. 8) performs the printing operations by controlling the aforementioned constituents according to printing commands received from an external device, e.g., a computer, or an operation portion (not shown) provided at an external side of the body 10. As the structure and operation of the control portion 11 are similar to those of the conventional image forming apparatus, these will not be described. In addition, the control portion 11 determines whether the print medium P passes through the fixing unit 60 by receiving the signal from the paper sensor 77 and perceiving whether the sensor actuator 70 pivots. Where a feed actuator 33 and a feed sensor 34 are disposed between the multi-feeding prevention roller 30 and the register roller 40, whether the print medium P is transferred is sensed by the signal sent from the feed sensor 34. The feed actuator 33 may be formed in a shape that is the same as or similar to the aforementioned sensor actuator 70.

An operation of the image forming apparatus 100 will be described with reference to FIGS. 4 and 8. When the printing command is received, the control portion 11 rotates the pickup roller 22 to pick the print medium P, loaded in the paper feed cassette 21, up one sheet at a time, to transfer the print medium P to the multi-feeding prevention roller 30. The multi-feeding prevention roller 30 transfers the print medium P fed by the pickup roller 22 to the register roller 40. Here, when two or more sheets of the print medium P are transferred by the pickup roller 22, only one sheet of the print medium P is transferred to the register roller 40 by the multi-feeding prevention roller 30.

The control portion 11 controls the rotation of the register roller 40 according to the signal of the feed sensor 34, so that the register roller 40 aligns the leading edge of the print medium P. The print medium P, aligned by the register roller 40, is transferred to the development unit 50. The development unit 50 forms the electrostatic latent image corresponding to the printing data on the photosensitive medium 51 and develops the image using toner, to form the toner image. Then, the transfer roller 52 transfers the toner image onto the print medium P. The print medium P, onto which the toner image is transferred, enters between the heating roller 61 and the pressure roller 62 of the fixing unit 60. The toner image that is formed on the print medium P is fixed on the print medium P by the heat of the heating roller 61 and the pressure of the pressure roller 62. As the heating roller 61 and the pressure roller 62 rotate, the print medium P, onto which the toner image is fixed, is transferred so as to push the sensor actuator 70 toward the first paper eject roller 91. While the print medium P is continuously transferred, the downward-facing side of the print medium P maintains contact with the toner sticking prevention member 80 disposed on the sensor actuator 70. Here, since the toner sticking prevention member 80 is made of the materials to which the toner that is printed on the downward-facing side of the printing medium does not stick to, the problem of toner that is printed on the downward-facing side of the print medium P sticking to the toner sticking prevention member 80 is not created.

When the sensor actuator 70 is pivoted by the print medium P as shown in FIG. 8, the sensor portion 73 of the sensor actuator 70 is pivoted out of the paper sensor 77. The paper sensor 77 then signals the control portion 11 that the sensor actuator 70 is pivoted. When a trailing edge of the print medium P passes the toner sticking prevention member 80 of the sensor actuator 70, the sensor actuator 70 pivots in the opposite direction such that the sensor portion 73 is repositioned in the sensing area of the paper sensor 77. At this time, the paper sensor 77 signals the control portion 11 that the sensor actuator 70 is returned to its original portion. The control portion 11 is, therefore, able to control the fixing unit 60 according to the signal of the paper sensor 77 and, further, the control portion 11 determines whether the print medium P is jammed between the sensor actuator 70 and the fixing unit 60.

The print medium P, passing through the sensor actuator 70, is ejected out of the body 10 of the image forming apparatus 100 by the first, second and third paper eject rollers 91, 92 and 93.

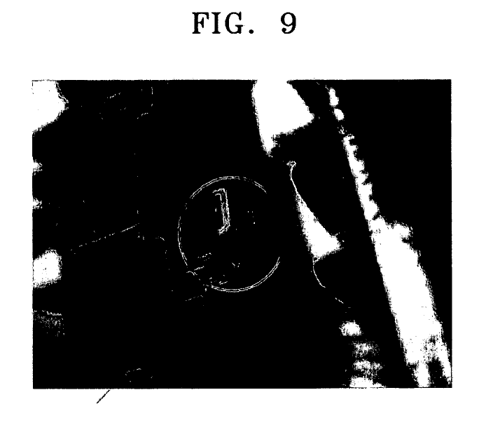

Experiments have been conducted to confirm that the toner does not stick to the toner sticking prevention member 80 after performing a relatively large amount of printing according to aspects of the present invention in which the toner sticking prevention member 80 of the present invention is used. That is, experiments have been conducted to check whether the toner sticks to the surface of the toner sticking prevention member 80 after printing numbers of sheets in multiples of one-thousand. According to the experiments, after printing 1,000 sheets, 2,000 sheets, 3,000 sheets, 4,000 sheets, 5,000 sheets and 6,000 sheets, whether the toner sticks to the top surface of the toner sticking prevention member 80 is checked. In these cases, none of the toner has been found to stick to the surface of the toner sticking prevention member 80. FIG. 9 is a photograph showing the toner sticking prevention member 80 after printing 6,000 sheets by the image forming apparatus 100 according to the present invention. From the portion encircled in FIG. 9, it may be seen that the toner does not accumulate on the toner sticking prevention member 80 after printing 6,000 sheets by the image forming apparatus 100 according to the prevention invention.

Although the case of disposing the sensor actuator 70 in the downstream of the fixing unit 60 is described as an example above, the application may be, of course, applied to the cases of disposing the sensor actuator 70 at other positions in the medium transferring path. That is, if the sensor actuator 70 is used to check the position of the print medium P and the toner printed on the downward-facing side of the print medium P sticks to the sensor actuator 70 to cause the jam or image scratch, solving these problems by disposing the toner sticking prevention member 80 on the sensor actuator 70 is possible.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus, including a body in which toner is applied to a printed side of a print medium during a printing operation, comprising:
a medium transferring path defined in the body, along which the print medium is transferred during the printing operation;
a sensor actuator, disposed in the medium transferring path, to be pivoted by the print medium as the print medium is transferred;
a toner sticking prevention member, disposed on the sensor actuator, to contact the printed side of the print medium as the print medium is transferred past the sensor actuator, the toner sticking prevention member being made of materials to which the toner does not stick;
a paper sensor to sense the pivoting of the sensor actuator; and
a control portion to perceive the transfer of the print medium according to a signal of the paper sensor.

2. The apparatus as claimed in claim 1, wherein the toner sticking prevention member comprises metallic materials.

3. The apparatus as claimed in claim 2, wherein the metallic materials are stainless steel (SUS).

4. The apparatus as claimed in claim 1, wherein the toner sticking prevention member covers an area of the sensor actuator that comes into contact with the print medium when the print medium causes the sensor actuator to pivot.

5. The apparatus as claimed in claim 4, wherein the toner sticking prevention member is disposed on the sensor actuator, with the toner sticking prevention member and the sensor actuator being engaged with each other.

6. An image forming apparatus, including a body in which toner of an image is applied to a printed side of a print medium during a printing operation, comprising:
a development unit, disposed in the body, to form the image on the print medium;
a fixing unit, disposed downstream from the development unit, to fix the image formed by the development unit onto the print medium;
a sensor actuator, disposed in the medium transferring path, to be pivoted by the print medium as the print medium is transferred;
a toner sticking prevention member, disposed on the sensor actuator, to contact the printed side of the print medium as the print medium is transferred passed the sensor actuator, the toner sticking prevention member being made of materials to which the toner does not stick;
a paper sensor to sense the pivoting of the sensor actuator; and
a control portion to perceive the transfer of the print medium according to a signal of the paper sensor.

7. The apparatus as claimed in claim 6, wherein the toner sticking prevention member comprises stainless steel (SUS).

8. The apparatus as claimed in claim 6, wherein the toner sticking prevention member covers an area of the sensor actuator that comes into contact with the print medium when the print medium causes the sensor actuator to pivot.

9. The apparatus as claimed in claim 8, wherein the toner sticking prevention member is disposed on the sensor actuator, with the toner sticking prevention member and the sensor actuator being engaged with each other.

10. An image forming apparatus, including a body in which toner is applied to a printed side of a print medium during a printing operation, comprising:
a medium transferring path defined in the body, along which the print medium is transferred during the printing operation;
a sensor actuating unit, disposed in the medium transferring path, to pivot upon contact between a surface thereof and the printed side of the print medium as the print medium is transferred, the surface of the sensor actuating unit being made of a material to which the toner does not stick;
a paper sensor to sense the pivoting of the sensor actuating unit; and
a control portion to perceive the transfer of the print medium according to a signal of the paper sensor to thereby control the printing operation.

11. The apparatus according to claim 10, further comprising:
a paper feed unit to feed the print medium into the apparatus;
a multi-feeding prevention roller to prevent the feeding of more than one print medium at a time;
a register roller to align a leading edge of the print medium with respect to the medium transferring path;
a development unit to form a toner image to be transferred to the print medium;
a fixing unit to fix the toner image on the print medium; and
a plurality of paper eject rollers to eject the print medium from the apparatus.

12. The apparatus according to claim 11, wherein the fixing unit comprises:
a heating roller to melt the toner on the print medium by an application of heat;
a pressure roller to pressurize the heating roller; and
a plurality of paper-rolling prevention units to prevent the print medium from adhering the heating roller.

13. The apparatus according to claim 12, wherein the sensor actuating unit is disposed downstream from the pressure roller and pivots at a predetermined angle upon contact with the print medium.

14. The apparatus according to claim 10, wherein the sensor actuating unit comprises:
a contact portion to contact the print medium;
a pivot axis about which the sensor actuating unit pivots; and
a sensor portion to operate a paper sensor.

15. The apparatus according to claim 14, wherein the sensor actuating unit further comprises a toner sticking prevention member, to which the toner does not stick, attached to the contact portion such that the toner sticking prevention member contacts the print medium.

16. The apparatus according to claim 15, wherein the toner sticking prevention member covers the contact portion.

17. The apparatus according to claim 16, wherein the toner sticking prevention member comprises stainless steel.

18. The apparatus according to claim 10, wherein the paper sensor is disposed at a lower part of the sensor actuating unit and signals the control portion to inform the control portion if the sensor actuating unit pivots.

19. An image forming apparatus, including a body having a transferring path defined therein in which toner is applied to a printed side of a print medium, which is transferred along the transferring path, during a printing operation, the apparatus comprising a sensor actuating unit, disposed in the transferring path, to pivot upon contact between a surface thereof and the printed side of the print medium as the print medium is transferred, the surface of the sensor actuating unit being made of a material to which the toner does not stick.

20. The apparatus according to claim 19, further comprising:
a paper feed unit to feed the print medium into the apparatus;
a multi-feeding prevention roller to prevent the feeding of more than one print medium at a time;
a register roller to align a leading edge of the print medium with respect to the transferring path;
a development unit to form a toner image to be transferred to the print medium;
a fixing unit to fix the toner image on the print medium; and
a plurality of paper eject rollers to eject the print medium from the apparatus.

21. The apparatus according to claim 20, wherein the fixing unit comprises:
a heating roller to melt the toner on the print medium by an application of heat;
a pressure roller to pressurize the heating roller; and
a plurality of paper-rolling prevention units to prevent the print medium from adhering the heating roller.

22. The apparatus according to claim 21, wherein the sensor actuating unit is disposed downstream from the pressure roller and pivots at a predetermined angle upon contact with the print medium.

23. The apparatus according to claim 19, wherein the sensor actuating unit comprises:
a contact portion to contact the print medium;
a pivot axis about which the sensor actuating unit pivots; and
a sensor portion to operate a paper sensor.

24. The apparatus according to claim 23, wherein the sensor actuating unit further comprises a toner sticking prevention member, to which the toner does not stick, attached to the contact portion such that the toner sticking prevention member contacts the print medium.

25. The apparatus according to claim 24, wherein the toner sticking prevention member covers the contact portion.

26. The apparatus according to claim 25, wherein the toner sticking prevention member comprises stainless steel.

27. The apparatus according to claim 23, further comprising a control portion to monitor the printing operation, wherein the paper sensor is disposed at a lower part of the sensor actuating unit and sends a signal to inform the control portion if the sensor actuating unit pivots.

28. An image forming apparatus, including a body having a transferring path defined therein in which toner is applied to a printed side of a print medium, which is transferred along the transferring path, during a printing operation, the apparatus comprising a sensor actuating unit, disposed in the transferring path, to pivot upon contact between a toner sticking prevention member connected to a surface thereof and the printed side of the print medium as the print medium is transferred, the toner sticking prevention member being made of a material to which the toner does not stick.
